(19) United States
(12) Patent Application Publication
(10) Pub. No.: US 2015/0013923 A1
(43) Pub. Date: Jan. 15, 2015

(54) CAMPING ACCESSORY DOORS FOR UTILITY TRAILER

(71) Applicant: Kevin Howe, Galesburg, IL (US)

(72) Inventor: Kevin Howe, Galesburg, IL (US)

(21) Appl. No.: 13/941,142

(22) Filed: Jul. 12, 2013

(51) Int. Cl. B60J 5/06

(52) U.S. Cl. CPC B60J 5/06
USPC 160/368.1

(57) ABSTRACT

An accessory for changing a utility trailer to a camping trailer. The accessory may include attachable canvas panels that may be formed to fit and cover the door openings of a trailer. The canvas panels may include screen windows that may be opened and closed. The canvas panels may further include doors so that a user may easily enter and exit the trailer housing.

### BACKGROUND OF THE INVENTION

The present invention relates to accessory doors for a utility trailer and, more particularly, to accessory doors for converting a utility trailer into a camping trailer.

Currently, trailers are very popular to transport motorcycles, ATVs, horses, and the like to events. In certain situations, the events may be camping events, and the individuals that camp must either sleep outside or bring additional camping gear. Sleeping outside may be uncomfortable, since the individual has to sleep on the ground. Further, insects may be an annoyance.

As can be seen, there is a need for an accessory that transforms a utility trailer into a suitable camping trailer.

### SUMMARY OF THE INVENTION

In one aspect of the present invention, a trailer add-on device comprises: at least one canvas panel comprising an attachment component at least partially along a parameter of the at least one canvas, wherein the attachment component is configured to be releasably attachable to a trailer and the at least one canvas is formed to cover at least one trailer door, and wherein the canvas panel comprises at least one screen window.

In another aspect of the present invention, a trailer camping conversion apparatus comprises: a housed trailer comprising at least one door opening comprising a top, a bottom, a first side and a second side; a roll up component attached to at least one of the top, the bottom, the first side, and the second side; and a canvas panel within the roll up component, wherein the canvas panel is in a retracted position and an extended position, wherein the retracted position comprises the canvas panel rolled up within the roll up component, and the extended position comprises the canvas panel substantially covering the at least one door opening.

These and other features, aspects and advantages of the present invention will become better understood with reference to the following drawings, description and claims.

### BRIEF DESCRIPTION OF THE DRAWINGS

FIG. 1 is a rear perspective view of the present invention in use;

FIG. 2 is a cross-sectional view taken along line 2-2 of FIG. 1;

FIG. 3 is a cross-sectional view taken along line 3-3 of FIG. 2;

FIG. 4 is a rear perspective view showing the components of the present invention in a second embodiment; and

FIG. 5 is a rear perspective view of the second embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an accessory for changing a utility trailer to a camping trailer. The accessory may include attachable canvas panels that may be formed to fit and cover the door openings of a trailer. The canvas panels may include screen windows that may be opened and closed. The canvas panels may further include doors so that a user may easily enter and exit the trailer housing.

The present invention may include a tent or canvas material that may have screen windows to cover the rear and side door openings of a utility trailer to convert the trailer into a camping space. The present invention may be made for common sized utility trailers and may be applied to a side door as well as the rear to facilitate needed air flow through the trailer as desired. In certain embodiments, the present invention may include windows that may be opened and closed from the inside to facilitate privacy and to control air flow. In certain embodiments, the windows may be opened by a zipper, hook and loop fastener, and the like.

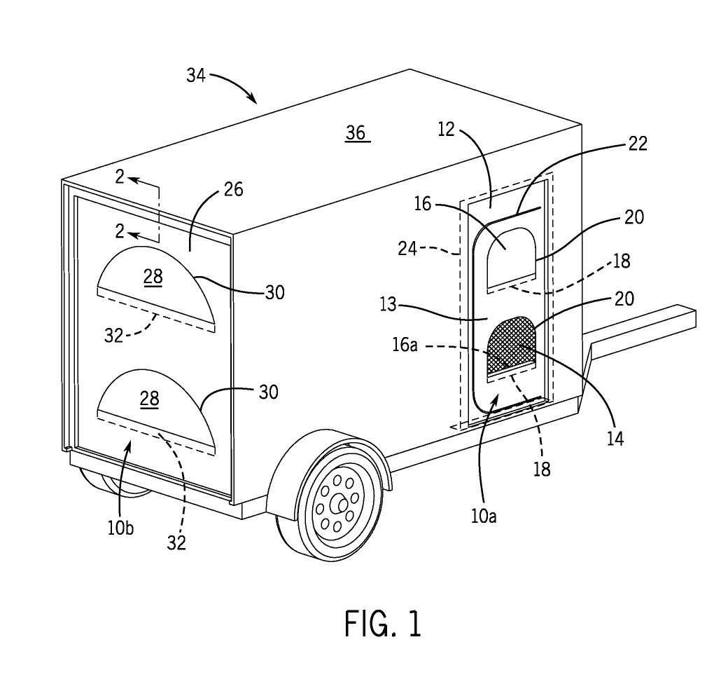

Referring to FIGS. 1 through 5, the present invention may include a tent add-on for a utility trailer 34. As illustrated in FIG. 1, the present invention may include a side door add-on 10a and a rear door add-on 10b. The side door add-on 10a and the rear door add-on 10b may be secured to the trailers 34 openings by an attachment component, such as a hook and look fastener 46, or may be secured to the trailer by a roller 40. The present invention may allow a user to easily convert a trailer 34 used for utility and transportation into a camping trailer 34.

In certain embodiments, the side door add-on 10a may be made of a canvas panel 12 similar to the material used for tents. The side door add-on 10a may include a door component 13 in which users may open and close to gain access to the inside of the trailer 34. For example, the door 13 may be opened and closed by a zipper 22. In certain embodiments, the side door add-on 10a may further include securing straps 50. As illustrated in FIG. 4, the securing straps 50 may secure the door 13 to the side and therefore keep the door 13 in an open position. In certain embodiments, the securing straps 50 may include a hook and loop fastener, clips, snap buttons, and the like.

The side door add-on 10a may further include at least one screen window 14. As illustrated in the Figures, the side door add-on 10a may include two screen windows 14. The screen windows 14 may be opened and closed. For example, when the screen window 14 is closed a canvas covering 16 may be covering the screen window 14. In certain embodiments, the present invention may include a pouch 18 for the canvas covering 16 to be stored when the screen window 14 is opened. In certain embodiments, the screen window 14 may be opened and closed using a window attachment component, such as a zipper 20.

In certain embodiments, the rear door add-on 10b may also be made of a canvas panel 26 similar to the material used for tents. The rear door add-on 10b may include at least one screen window 14. As illustrated in the Figures, the rear door add-on 10b may include two screen windows 14. The screen windows 14 may be opened and closed. For example, when the screen window 14 is closed a canvas covering 16 may be covering the screen window 14. In certain embodiments, the present invention may include a pouch 18 for the canvas covering 16 to be stored when the screen window 14 is opened. In certain embodiments, the screen window 14 may be opened and closed using a window attachment component, such as a zipper 20. In certain embodiments, the rear door add-on 10b may further include a door 22 as disclosed for the side door add-on 10a.

As mentioned above, the present invention may be attached to the trailer 34 by an attachment component at least partially along the parameter of the canvas panels 12, 26. The canvas panels 12, 26 are configured to be releasably attachable to the trailer 34, and the canvas panels 12, 26 are formed to cover the trailer door openings. For example, the attachment component may include a hook and loop fastener 24, such as Velcro®. As illustrated in FIG. 4, the hook and loop fastener 24 may be attached to the parameter of the side door opening of the trailer 34 and the parameter of the side door add-on 10a. Therefore, the edges of the side door add-on 10a may be attached to the side door opening of the trailer 34.

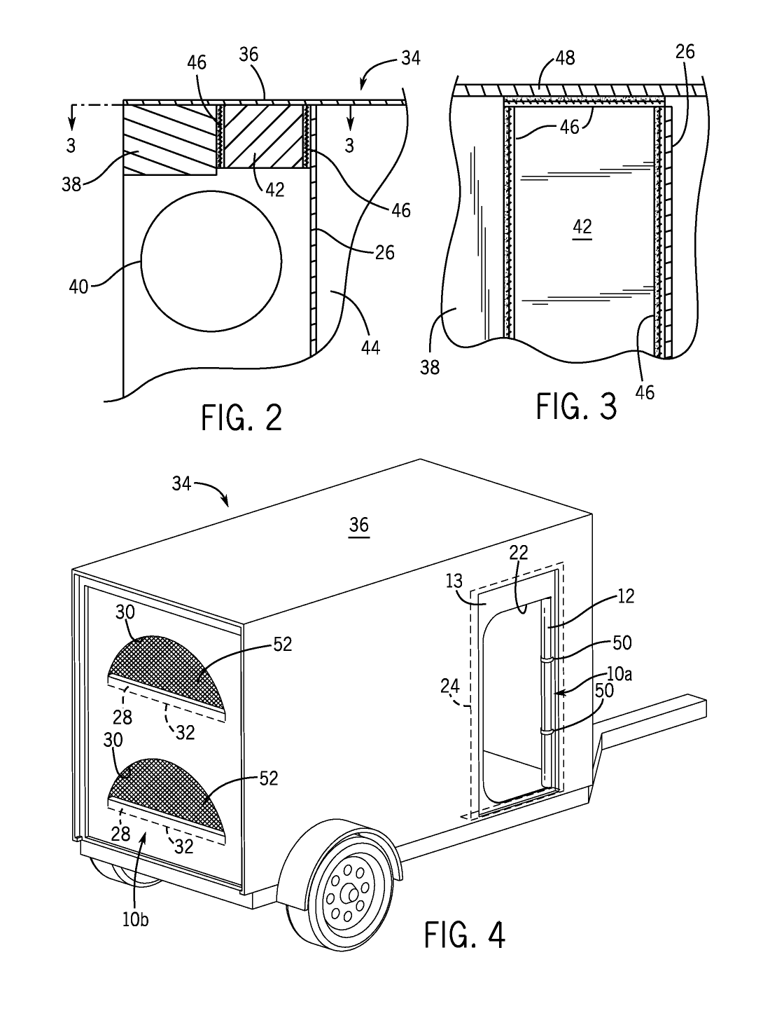

In certain embodiments, for the rear door add-on 10b, additional insert beams 42 may be used. As illustrated in FIGS. 2 and 3, an insert beam 42 may be attached to the crossbeam 38, and the roof 36 of the trailer 34. The crossbeam 38 of the trailer 34 may be above the roller 40 for the roll up door of the trailer 34. The insert beam 42 may include hook and loop fastener 24 around the parameter to securely attach to the crossbeam 38 to the trailer 34. The canvas panel 26 of the rear door add-on 10b may also attach to the side wall 44 of the trailer 34 by hook and look fastener 24.

In alternative embodiments, the present invention may further include a retractable side door add-on 10a and rear door add-on 10b. A housed trailer 34 may include at least one door opening having a top, a bottom, a first side and a second side and a roll up component 60 attached to at least one of the top, the bottom, the first side, and the second side. The canvas panel 12, 26 may be within the roll up component 60. In certain embodiments, the canvas panel 12, 26 may be in a retracted position and an extended position. The retracted position may include the canvas panel 12, 26 rolled up within the roll up component, and the extended position may include the canvas panel substantially covering the at least one door opening. In certain embodiments, the canvas panel 12, 26 may be spring biased within the roll up component.

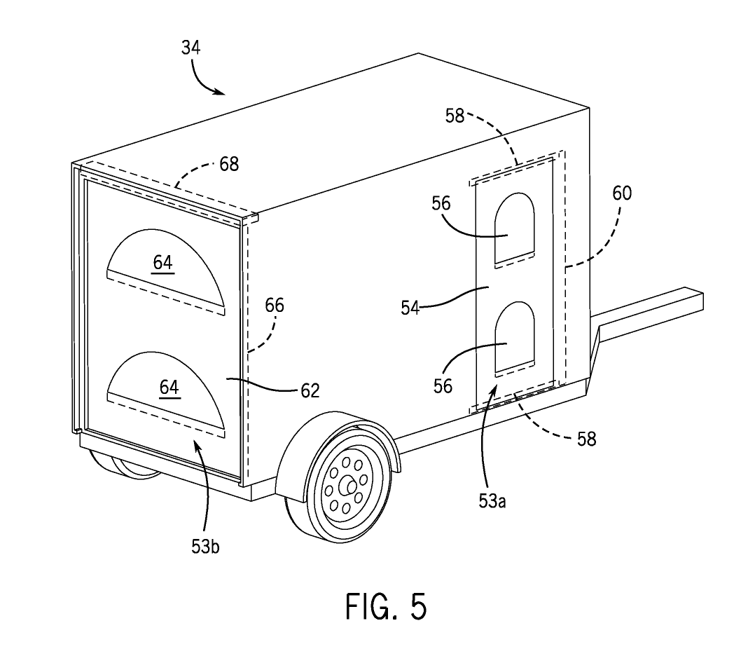

As illustrated in FIG. 5, the side door add-on 10a may include the roll-up component 60 mentioned above. In such embodiments, the side door add-on 10a may be rolled within the roll-up component 60, and then pulled out from the roll-up component 60 when the side door add-on 10a is ready to be used. The roll-up component 60 may be attached to the trailer 34 at the side door opening. In certain embodiments, the trailer 34 may further include upper and lower tracks 58. Therefore, the canvas panel 12 may be pulled and the edges of the canvas panel 12 may be within the tracks 58.

As illustrated in FIG. 5, the rear add-on 10b may include the roll-up component 60 mentioned above. In such embodiments, the rear door add-on 10b may be rolled within the roll-up component 60, and then pulled out from the roll-up component 60 when the side door add-on 10a is ready to be used. The roll-up component 60 may be attached to the trailer 34 at the rear opening. In certain embodiments, the trailer 34 may further include side tracks 66. Therefore, the edges of the canvas panel 26 may be within the side tracks 66 when the rear add-on 10b is deployed.

It should be understood, of course, that the foregoing relates to exemplary embodiments of the invention and that modifications may be made without departing from the spirit and scope of the invention as set forth in the following claims.

What is claimed is:

1. A trailer add-on device comprising:
at least one canvas panel comprising an attachment component at least partially along a parameter of the at least one canvas panel, wherein the attachment component is configured to be releasably attachable to a trailer and the at least one canvas is formed to cover at least one trailer door, and wherein the canvas panel comprises at least one screen window.

2. The trailer add-on device of claim 1, wherein the at least one canvas panel comprises a side-door add-on and a rear door add-on, wherein the side-door add-on is formed to cover a side door opening of the trailer and the rear door add-on is formed to cover a rear door opening of a trailer.

3. The trailer add-on device of claim 1, wherein the attachment component is a hook and loop fastener.

4. The trailer add-on device of claim 1, further comprising a canvas covering overlapping the at least one screen window, wherein the canvas covering comprises a window attachment component, wherein the canvas covering is in a closed position and an open position, wherein the closed position comprises the window attachment component of the canvas covering attaching to the at least one canvas panel and overlapping the at least one screen window, and wherein the open position comprises the attachment component detached, exposing the screen window.

5. The trailer add-on device of claim 4, further comprising a canvas covering pouch, wherein in the open position the canvas covering is stored in the canvas covering pouch.

6. The trailer add-on device of claim 4, wherein the window attachment component is a zipper.

7. The trailer add-on device of claim 3, further comprising a door portion on the canvas panel, wherein the door portion comprises a door zipper, wherein the door portion comprises an open position and a closed position, wherein the open position comprises the zipper being unzipped and the closed position comprises the zipper being zipped

8. The trailer add-on device of claim 7, further comprising straps, wherein the straps secure the door portion in the open position.

9. A trailer camping conversion apparatus comprising:
a housed trailer comprising at least one door opening comprising a top, a bottom, a first side and a second side;
a roll up component attached to at least one of the top, the bottom, the first side, and the second side; and
a canvas panel within the roll up component, wherein the canvas panel is in an retracted position and an extended position,
wherein the retracted position comprises the canvas panel rolled up within the roll up component, and the extended position comprises the canvas panel substantially covering the at least one door opening.

10. The trailer camping conversion apparatus of claim 9, further comprising screen window in the canvas panel.

11. The trailer camping conversion apparatus of claim 9, wherein the canvas panel comprises at least one of a side-door add-on and a rear door add-on.

12. The trailer camping conversion apparatus of claim 10, further comprising a canvas covering overlapping the at least one screen window, wherein the canvas covering comprises a window attachment component, wherein the canvas covering is in a closed position and an open position, wherein the closed position comprises the window attachment component of the canvas covering attaching to the canvas panel and overlapping the at least one screen window, and wherein the open position comprises the attachment component detached, exposing the screen window.

13. The trailer camping conversion apparatus of claim 12, further comprising a canvas covering pouch, wherein in the open position the canvas covering is stored in the canvas covering pouch.

14. The trailer camping conversion apparatus of claim 12, wherein the window attachment component is a zipper.

15. The trailer camping conversion apparatus of claim 9 further comprising a door portion on the canvas panel, wherein the door portion comprises a door zipper, wherein the door portion comprises an open position and a closed position, wherein the open position comprises the zipper being unzipped and the closed position comprises the zipper being zipped

16. The trailer camping conversion apparatus of claim 15, further comprising straps, wherein the straps secure the door portion in the open position.

17. The trailer camping conversion apparatus of claim 9, further comprising at least one track along at least one of the top, the bottom, the first side, and the second side.

18. The trailer camping conversion apparatus of claim 9, wherein the canvas panel is spring biased in the retracted position.
